(19) United States
(12) Patent Application Publication
(10) Pub. No.: US 2003/0225563 A1
(43) Pub. Date: Dec. 4, 2003

(54) Capacity planning

(76) Inventor: Dan G. Gonos, Folsom, CA (US)

Correspondence Address: FISH & RICHARDSON P.C., 1425 K STREET, N.W., 11TH FLOOR, WASHINGTON, DC, 20005-3500, US

(21) Appl. No.: 10/157,025

(22) Filed: May 30, 2002

(51) Int. Cl. G06F 9/45

(52) U.S. Cl. 703/22

(57) ABSTRACT

Information gathered from functional, technical, or management work products. is used to generate predictive models and reports that may be used in capacity planning for a computer application program. Capacity planning information may be entered into a database from which predictive models and reports are generated.

### TECHNICAL FIELD

This description relates to techniques for capacity planning for a computer system.

### BACKGROUND

Computer system sizing and capacity planning is performed to estimate the resource requirements needed to operate a computer system running one or more application programs, such as a product lifecycle management system, an enterprise resource management system, a financial management system, a human resources management system, or a supply chain management system. A distinction may be made between computer system sizing and capacity planning. The process of defining hardware requirements for a planned application program may be referred to as sizing. Capacity planning may be used to refer to estimating resource requirements for an existing application program.

During the planning, delivery, and installation of an application program for a computer system, computer system sizing and capacity planning may be performed. Often computer system sizing and capacity planning is performed by a person making a reasoned judgment based on system information available to that person. This is sometimes referred to as an expert judgment approach.

### SUMMARY

In one general aspect, capacity planning includes providing planning information to one or more computer systems, generating one or more predictive models using the provided planning information and at least one of the computer systems, validating the predictive models using at least one of the computer systems, and generating a capacity model based on the predictive models using at least one of the computer systems. Generating and validating the predictive models and generating the capacity model is repeated as more planning information is provided.

Implementations may include one or more of the following features. For example, planning information may include system component information, compute device information, data model information, data usage information, process model information, location information, and application program information, such as data structure information or function information.

The predictive models that may be generated include a data class model, a case use model, a communication traffic model, a transaction model, a database growth model, and a utilization model, such as a memory utilization model, a disk utilization model, or a database growth model. Predictive models may be validated by using a system simulation model.

The capacity model generated may include memory requirements, disk requirements, and processor requirements for one or more components in a computer system.

Capacity planning may include loading capacity planning information into a data modeling system and using the data modeling system to generate predictive models or the capacity model.

During the planning, delivery, installation, and operation of a computer system or a new application program, decisions about what type of hardware, software, or other system components are needed often may be made with minimal knowledge about what capacity is needed. The installation or operation of a new computer system or application program may be delayed when computer system capacity decisions are made with inadequate information. When capacity requirements for an operating computer system increase, inadequate capacity planning information may hamper the operation of the computer system as capacity requirements exceed capacity and the performance of the computer system decreases.

The accuracy of capacity planning may be improved when capacity planning information is collected and provided to people who are performing capacity planning for an application program or computer system. Collecting and providing a variety of capacity planning information, such as functional and technical work products, user surveys, and management considerations, may result in improved capacity planning.

Capacity planning also may be more accurate when capacity planning information is used to generate predictive models for use in capacity planning. Increasing the types and variety of predictive models generated may result in more accurate capacity planning.

Capacity planning information that is collected and predictive models that are produced may be used throughout the planning, delivery, installation, and operation of a computer system. The predictive models may be revised as additional information is collected or expert judgment is applied. Improved capacity planning accuracy may result in reduced risks of failure when implementing a new computer system application program.

Implementations of the techniques discussed above may include a method or process, or computer software on a computer-accessible medium.

The details of one or more of the implementations are set forth in the accompanying drawings and description below. Other features will be apparent from the description and drawings, and from the claims.

### DESCRIPTION OF THE DRAWINGS

FIG. 1 is a flow chart of a process for capacity planning.

FIG. 2 is a flow chart of a process for gathering capacity planning information.

FIGS. 3-10 are flow charts of processes for building predictive models and producing capacity planning reports.

FIG. 11 is a block diagram illustrating an exemplary computer system capable of implementing a capacity planning process.

FIG. 12 is a flow chart of a process for generating a capacity model.

FIG. 13 is a flow chart of a process for loading model element data into a capacity planning model and generating predictive models.

Like reference symbols in the various drawings indicate like elements.

### DETAILED DESCRIPTION

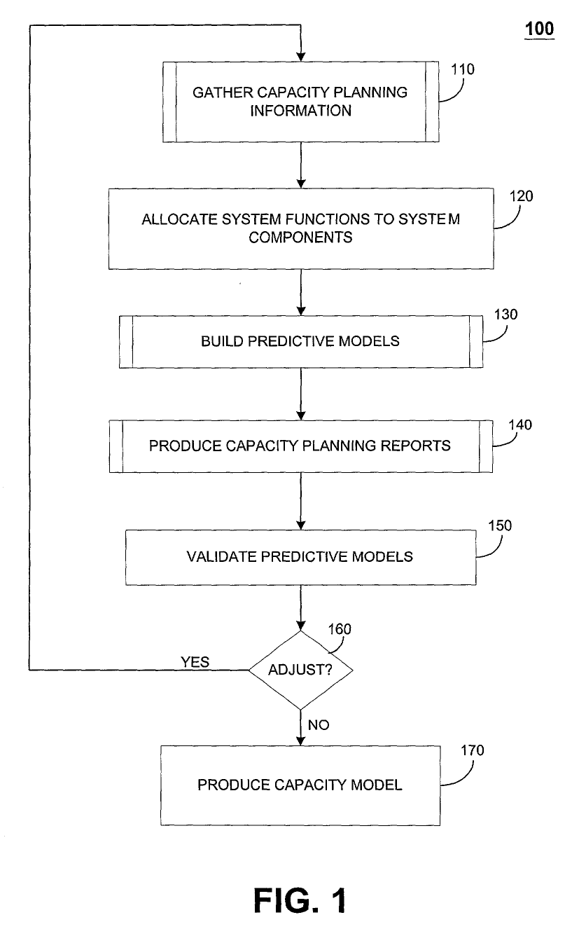

Referring to FIG. 1, a capacity planning process 100 includes sizing and capacity planning techniques to determine the computer system components (typically the amount and type of hardware components) necessary to support the performance requirements of the application program. Capacity planning may be performed for incorporation of an application program into a new or an existing computer system or network of computer systems. As the planning, delivery, and installation of an application program progresses, additional information may become available that is useful for capacity planning. The capacity planning process 100 may be performed throughout the planning, delivery, installation, and operation of a computer system as more information is available.

The capacity planning process 100 also may be performed for an operating application program on an existing computer system to determine the amount and kind of hardware necessary to support increased workloads on the computer system from the application program.

The capacity planning information, models, reports, and other information produced during the capacity planning process 100 may be provided to people interested in the application program for which the capacity planning is being performed. This may encourage the development of additional information and analysis which may be collected and used to form a further basis for the capacity model developed. Thus, by repeating the process throughout the planning, delivery, and installation of an application program for a computer system, the accuracy of the capacity planning may be improved.

The process 100 is performed by a person working alone or as part of a group. The person or group may be referred to as a capacity planner.

The process 100 begins with gathering capacity planning information (step 110). The purpose of gathering capacity planning information is to identify potential constraints and requirements that might affect the type and amount of hardware needed to support an application program. Capacity planning information may be provided by the users of the application program, people participating in the planning, delivery, installation or operation of the application program, or any other person with information that may be useful for capacity planning. Typical information that may be available during the course of the planning, delivering, installing, and operating an application program includes functional work products (such as functional requirements, functional specifications, and management reports), technical work products (such as design specifications, use case descriptions, and data models), existing system component information (such as hardware specifications, software specifications, and physical database descriptions), management information (such as management reports and contractual requirements for computer equipment or the application program), and surveys that identify and/or quantify functions that the application program may perform.

Using the gathered capacity planning information, the functions that are performed or are to be performed by the application program are allocated to components of the computer system (step 120). Computer system components include compute elements, such as an enterprise server, a geographical region server, an application server, a database server, desktop computers, and PDAs (personal digital assistants). Allocating system functions to system components (step 120) may be accomplished by identifying the system components, identifying each discrete system function, and allocating each system function to a system component. The allocation of system functions to system components may result in a preliminary system model that describes the number and type of various compute elements needed for the computer system application program. If the computer system is a distributed system (that is, with compute elements located in separate geographical locations), the preliminary system model may include the expected or actual geographical location of one or more of the various compute elements. The system model may be revised during the capacity planning process 100 and as further iterations of the capacity planning process 100 are performed.

Using the gathered capacity planning information and, optionally, the preliminary system model, one or more predictive models are built (step 130). A predictive model organizes the capacity information around an aspect of the system, such as memory use, disk use, database growth, use cases, or traffic distribution. Typically, a base system model is produced that supports the building of other predictive models. A base system model includes one or more system architectures, such as an application architecture that describes the user interface, data access, and decision logic (which also may be referred to as business rules); information architecture that describes the data required by the application program; infrastructure architecture that describes the compute devices and communication devices required; and system management architecture (for instance, hardware maintenance schedule, database maintenance schedule, system availability schedule, and disaster recovery plans or information).

One or more capacity planning reports may be produced (step 140) from one or more predictive models. Capacity planning reports may include a memory utilization report, a disk utilization report, a database growth report, a use case report, and a traffic distribution report.

The predictive models then are validated (step 150). The validation includes reviewing the predictive models and the capacity planning reports for accuracy and reasonableness. If the predictive models or capacity planning reports are not accurate or do not seem reasonable (i.e., adjustments are needed) (step 160), the process continues by gathering additional capacity planning information (step 110) and proceeding as described above. Additionally or alternatively, the predictive models may be adjusted by the capacity planner.

Some implementations may use a system simulation model to validate the predictive models. Typically, a simulation model is loaded with system component and workload assumptions from the predictive models and capacity planning reports. The simulation model then is run to simulate the application program workload, and the results are reviewed and analyzed. If the simulation results indicate adjustments are needed to the predictive models or capacity planning reports (step 160), then the process continues by gathering capacity planning information (step 110) and proceeding as described above. Additionally or alternatively, the predictive models may be adjusted by the capacity planner.

If the predictive models and capacity planning reports are valid (i.e., adjustments are not needed) (step 160), a capacity model is produced (step 170). The capacity model describes the compute devices and communication devices (which collectively may be referred to as system components) required for the application program. The capacity model documents by system component the capacity requirements needed to support the application program. For each system component, the capacity model may include information such as component identifier, memory requirements, disk requirements, and processor requirements.

The capacity model may describe one or more configurations, such as a minimum necessary configuration or a recommended configuration, for each system component. The configuration in the capacity model may be based only on the information gathered or may include additional capacity for expected growth. For instance, the capacity model for a system component may indicate a configuration that includes capacity estimated for a predetermined amount of time (e.g., the next two years of operation) or a percentage of transactions (e.g., allows for 20% system growth).

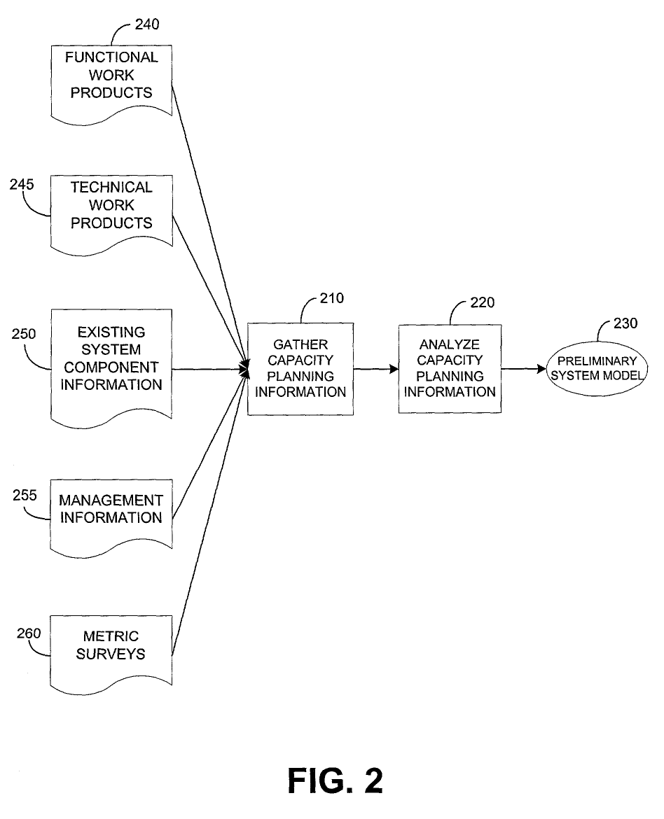

Referring to FIG. 2, a process 200 for gathering capacity planning information seeks to identify potential constraints and requirements that might affect the type and amount of system components needed. The process 200 is performed by the capacity planner or other individuals who gather information about the system from a variety of sources, including users and people involved in any aspect of the planning, delivery, installation, and operation of the application program.

The process 200 includes gathering information that may be used for capacity planning (step 210) and analyzing the gathered information (step 220) to identify constraints and requirements and develop a preliminary system model (230).

The types of information gathered may include one or more functional work products 240, technical work products 245, existing system component information 250, management information 255, and metric surveys 260.

Gathered functional work products 240 may include documents that identify functional requirements and constraints, management reports, a logical process model, a physical process model, and documents identifying objects or programs used in the system.

Gathered technical work products 245 may include, for example, documents that identify technical requirements and constraints, a conceptual data usage analysis report, a logical data usage analysis report, a conceptual data model, a logical data model, a physical data model, and physical database requirements.

Gathered existing system component information 250 may include hardware specifications and software specifications.

Gathered management information 255 may include management reports and contractual constraints for any contracts associated with the application program.

Gathered metric surveys 260 may include surveys to identify and/or quantify functions of the system.

The amount and type of information available about an application program varies throughout the phases of application program planning, delivery, installation, and operation. The goal of process 200 is to gather and analyze whatever information is available about the application program for use during the capacity planning process. The capacity planning process 100 and the capacity planning information gathering process 200 may be repeated throughout the phases of system delivery, installation, and operation to increase the accuracy of the capacity planning model.

The preliminary system model 230 produced by the process 200 may include a description of the system architecture, the database requirements, and the functions supported by the system. A preliminary description of the system architecture may be produced by analyzing functional requirements documents, technical requirements documents, management requirements (including contractual requirements), data usage reports, and existing system component information. A preliminary description of the database requirements may be produced by analyzing data models or physical database descriptions or requirements. A preliminary description of the functions to be supported in the system may be produced by analyzing metrics surveys, management reports, and object/program documentation.

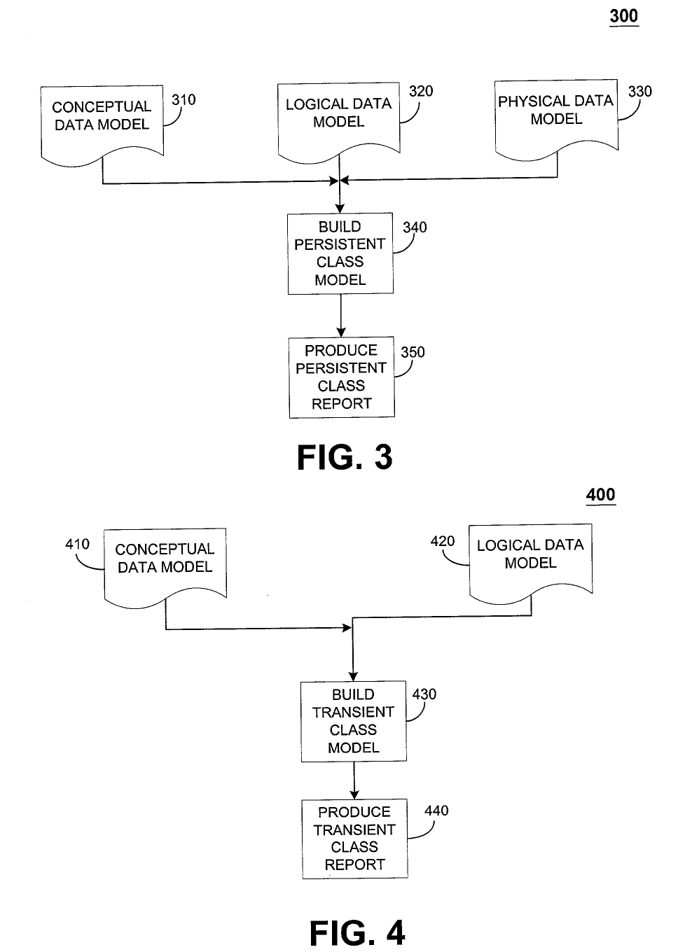

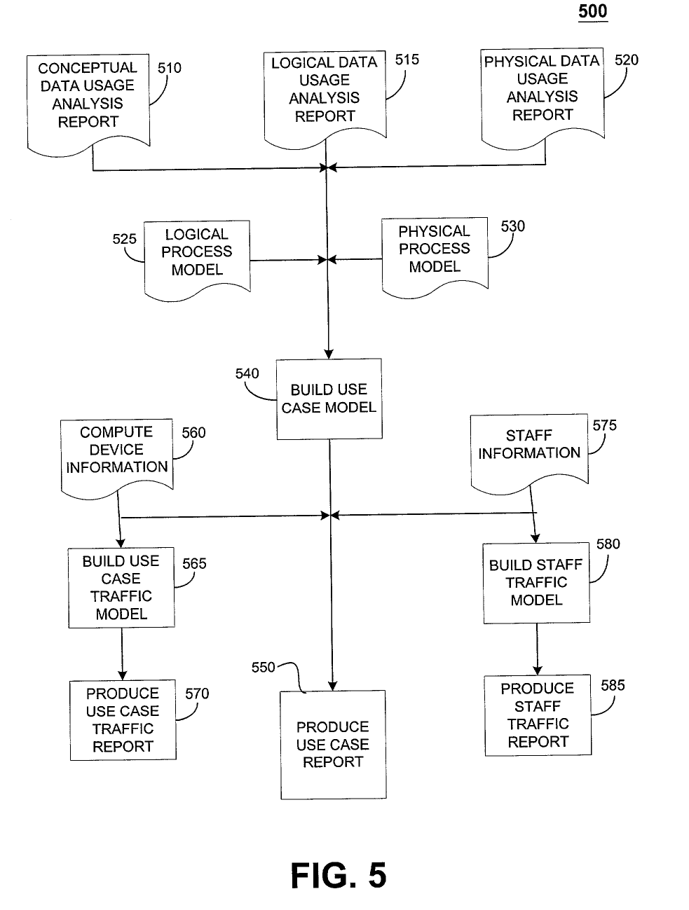

Referring to FIGS. 3-10, using portions of information derived from the gathered capacity planning information, predictive models are built and capacity planning reports are produced. Some gathered information may be used in more than one predictive models. Some models may be built from gathered information and other types of predictive models, as shown FIG. 5.

For illustrative purposes, a particular implementation of a capacity planning process is described. In the described implementation, a relational database management system, such as an Oracle 8 Database or an Oracle 9i Database available from Oracle Corporation, or Informix data management software from IBM®, is used to store data for the application program for which capacity planning is being performed. The relational database logically organizes data into a series of database tables. A database table arranges data associated with an entity in a series of columns and rows. Each column describes an attribute of the entity for which data is being stored. Each row represents a collection of attribute values for a particular entity.

FIG. 3 illustrates a process 300 for building a persistent class model and producing a persistent class report. The persistent class model may be developed for all or some of the persistent classes in the computer system application program. Depending on the availability of data models, information from a conceptual data model 310, a logical data model 320, and a physical data model 330 may be used to build a persistent class model (step 340). Any or all of the data models may be used to build the persistent class model. The persistent class model may be developed iteratively as the various types of data models are developed and modified. For instance, the persistent class model may be developed initially using only a conceptual data model. The same persistent class model may be modified using a logical data model when all or some of the logical data model is available. The persistent class model may be modified any number of times as information is developed.

The persistent class model describes types of information physically stored, for example, in one or more relational database tables or object classes, and for each type of information (or persistent class), the amount and type of storage needed. For example, a persistent class may include information about customers, invoices, or reference data. For data stored in a relational database table, the persistent class model may include a record for each type of persistent class. Each record may include the persistent class name, the number of rows expected for the persistent class, the number and types of attributes for the persistent class, the total amount of storage required for the persistent class, and the type of storage (e.g., online disk, secondary disk storage, DVD, or tape). Some implementations may include the number of columns and the number of tables used for the persistent class. From the persistent class model, a persistent class report is produced (step 350). The persistent class report is a capacity planning report that provides information about the persistent class model.

FIG. 4 shows a process 400 for building a transient class model and producing a transient class report. The transient class model describes data (such as results sets produced from database queries) that may be transmitted between communication devices and that are not permanently stored in the database or files. A transient class model may include a record for each type of transient class having the transient class name, the number of rows expected for that transient class, the number and types of attributes for the transient class, the total amount of storage required for the transient class, and the type of storage (e.g., memory, online disk, or secondary disk storage). Some implementations may include the number of columns (data elements or attributes), the number of tables used for the transient class, and the duration and frequency at which the transient class is expected to be produced.

As model data is available for transient classes, conceptual model data 410 and/or logical model data 420 may be used to develop a transient class model (step 430). The transient class model may be developed and modified iteratively as relevant information becomes available.

From the transient class model, a transient class report is produced (step 440). The transient class report is a capacity planning report that includes information from the transient class model.

FIG. 5 illustrates a process 500 for building a use case model and producing a use case report. Information from a conceptual data usage analysis report 510, a logical data usage analysis report 515, a physical data usage analysis report 520, a logical process model 525, and/or a physical process model 530 may be used to build a use case model (step 540). The use case model may be modified repeatedly as information becomes available or is modified.

The use case model describes the how users may use the computer system application program to perform one or more business processes or transactions. For example, a use case may describe how an invoice is processed or how a record for a new customer is entered into the application program.

The use case model includes a record for each use case (which may also be called an interaction). The record describes the interaction and information relating to compute device and communication device capacity requirements. The descriptive information for each interaction may include an interaction identification number and text description, the category of the interaction (such as invoice processing or entering new client information), the aspect of the system (often called a subsystem) to which the interaction relates, one or more user roles that are involved in performing the interaction, and the primary actor for the interaction.

Information relating to resource requirements for compute device capacity and communication device capacity may include the type of compute devices that perform the interaction, a description of communication messages (such as the number and length of originating and responding communication messages) sent from one compute device to another during the interaction, an indication as to whether the communication is real time or initiated through a batch operation, an indication as to whether the response is synchronous or asynchronous, the average number of times per day that the interaction occurs, whether the interaction may create additional tasks, the number of rows impacted by each occurrence of the interaction, the number of columns impacted by each occurrence of the interaction, the response time requirement for the interaction, the memory required for the interaction, the source of the information used to describe the interaction, and the database profile (such as whether rows are inserted, modified, or deleted) of the interaction.

From the use case model, a use case report that defines user or system activities is produced (step 550). The use case report is a capacity planning report that includes information from the use case model.

Optionally, compute device information 560 is used with the use case model to build a use case traffic model (step 565). The use case traffic model estimates the communication traffic sent between communication devices. The use case traffic model includes a textual description of the interaction, the primary originating site, the primary originating compute device, the primary destination compute device, the primary destination site, an indication as to whether the primary destination site is local or remote from the primary originating site, the mode of interaction (e.g., whether real time or batch-initiated), the length of the originating message, the length of the destination message, an indication as to whether the communication is sent only within a local area network, an indication as to whether the communication is only through a wide-area network, the total bytes per day from originating system messages, the total bytes per day from destination system messages, the number of peak messages per day, an average number of messages per hour at a minimum traffic rate, an average number of messages per hour at a peak traffic rate, a minimum average hourly bandwidth required, and a peak average hourly bandwidth required. The use case traffic model is used to produce the use case traffic report (step 570). The use case traffic report is a capacity planning report that estimates the number of communication messages (which may be referred to as traffic) that may be generated.

Alternatively or additionally, staff information 575 and the use case model may be used to build a staff traffic model (step 580). A staff traffic model estimates the traffic resulting from activities between devices by staff role. The staff traffic model includes a textual description of the interaction and identifies the user role or roles that perform the interaction, the application program system that performs the interaction, the average bandwidth per hour at a minimum and at peak for each user role that performs the interaction, and a minimum and peak system average bandwidth per hour. A staff traffic report that defines communication traffic resulting from activities between devices by staff role may be produced (step 585).

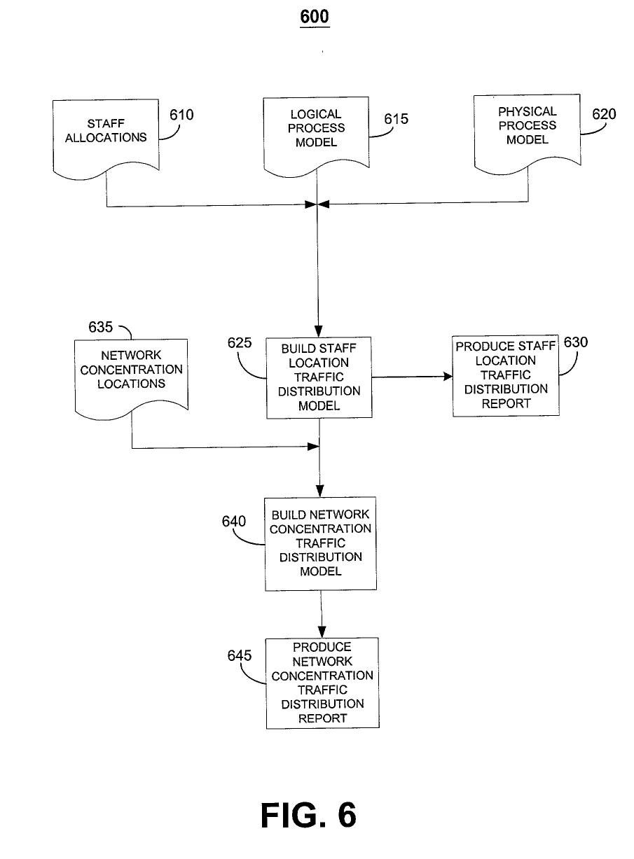

Referring to FIG. 6, a process 600 for building a staff location traffic distribution model (step 625) and producing a staff location traffic distribution report (step 630) may include staff allocation information 610, a logical process model 615, and a physical process model 620. A staff location traffic distribution model describes the communication traffic resulting from activities between devices by staff role by location. The staff location traffic distribution model includes an identification of the physical site, the address of the physical site, the area code and prefix (which together may be referred to as the “LSO” (Local Serving Office)) for the telephone number of the physical site, an indication of how the site communicates (e.g., whether the site is connected directly to the network or communicates through one or more dial-up telephone connections), the name of the physical site, the number of particular user roles at the site, the total number of users at the site, the percent of a particular user role in the entire organization located at the site, the percent of total staff located at the site, the minimum and peak staff average hourly bandwidth for the various user roles at the site, a system average bandwidth per hour at a minimum and at peak, and a total average bandwidth per hour at a minimum and at peak.

Optionally, network concentration location information 635 may be used with the staff location traffic distribution model to build a network concentration traffic distribution model (step 640). The network concentration traffic distribution model describes the consolidation of the communication traffic by network concentration location. The network concentration traffic distribution model includes information about each network concentration, such as network concentration identification, peak local backbone bandwidth bits per second, peak WAN (Wide Area Network) backbone bandwidth bits per second, and type of access circuitry (such as DS1, DS3, T1, T3, or SONET). A network concentration traffic distribution report may be produced from the network concentration traffic distribution model (step 645).

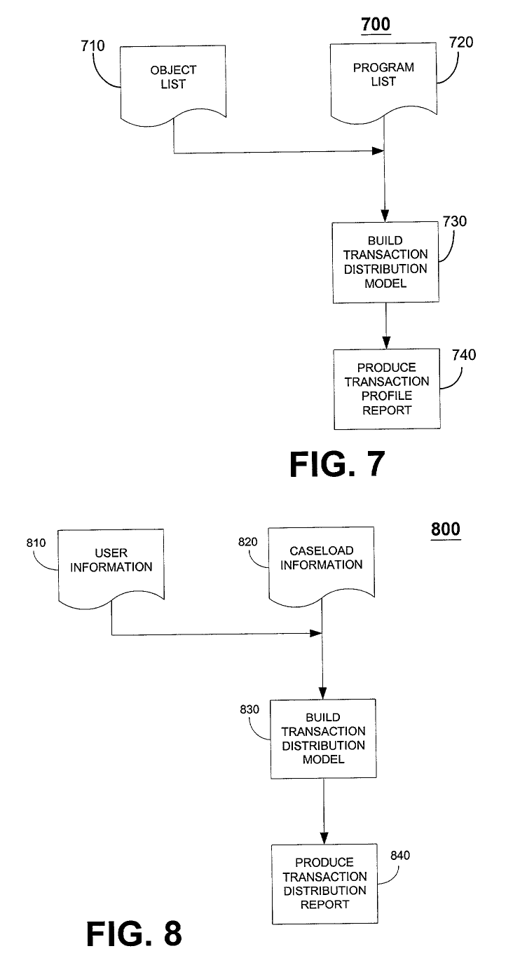

FIG. 7 illustrates a process 700 for building a transaction profile model. Object or entity list information 710 and program list information 720 for the application program is used to build a transaction profile model (step 730). The transaction profile model includes the interaction identification number, the subsystem of the application program to which the interaction belongs, a textual description of the interaction, the average number of times per day that the interaction occurs, whether the interaction is synchronous or asynchronous, the database profile of the interaction (such as whether rows are inserted, modified or deleted), the number of tables impacted by each occurrence of the interaction, the number of rows impacted by each occurrence of the interaction, the number of columns impacted by each occurrence of the interaction, the approximate row size, the approximate row size adjusted by some factor, the number of source code instructions used to perform the interaction, the relative importance of the interaction (such as very high, high, average, or low), the number of spanned interactions, the number of spanned interactions adjusted by some factor, the number of asynchronous interactions, the number of synchronous interactions, the number of bytes in communication traffic, the primary compute device used for the interaction (which may be referred to as the primary processing platform), the amount of CPU time or cycles required for the interaction, the amount of memory required for the interaction, the number of transactions per second needed to support the interaction at peak capacity, the amount of compute device CPU required, the amount of server memory required, the number of compute device logical I/O operations, the compute device logical I/O size, the number of compute device read operations, and the number of compute device write operations. The transaction profile model may be used to produce the transaction profile report (step 740).

FIG. 8 shows a process 800 for building a transaction distribution model. User information 810 and caseload information 820 is used to build a transaction distribution model (step 830). The transaction distribution model describes transaction rates by organization site by aggregating transaction workload for an organization that is located in separate geographical locations. For example, a transaction may be the number of product orders processed, the number of invoices processed, or the number of cases managed by a social service agency. The transaction distribution model includes a record for each organization site that summarizes the transaction workload that may occur at the organization site during a period of time (such as a day, a week, or a month). The transaction record for an organization site may include an organization site identifier, the number of transactions performed, the percentage of all transactions performed by the organization that are performed at the organization site, the number of users at the organization site, the percentage of all users in the organization that are located at the organization site, the number of daily transactions at the organization site (which may be referred to as the base daily transaction number), the adjusted daily transaction number (which is the base daily transaction rate multiplied by some factor, such as twenty percent) and the peak number of transactions at the organization site. Some implementations may develop separate transaction distribution models for different types of transactions performed by an organization. A transaction distribution report that defines transaction rates by organization may be produced (step 840) from the transaction distribution model.

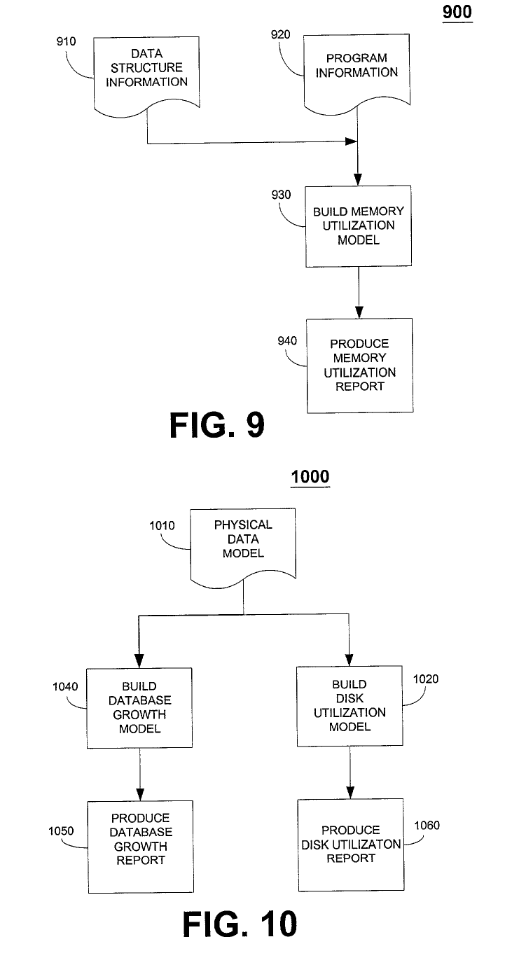

FIG. 9 illustrates a process 900 for building a memory utilization model. Data structure information 910, such as the size and number of database tables (or objects) used by the system, and program information 920 that may include program module or object method memory requirements, is used to build a memory utilization model (step 930). The memory utilization model describes the necessary memory by compute device. For each type of compute device, the memory utilization model includes information about the amount of memory (typically, measured in megabytes) required by various compute device components, such as an operating system, a database management system kernel, a database management system transaction manager, a database management system memory connection, other compute device elements, the sum of the memory required by all the compute device components (which may be referred to as the amount of base memory required), and the adjusted amount of base memory required (which is the base memory required multiplied by some factor, such as twenty percent). A memory utilization report may be produced from the memory utilization model (step 940).

FIG. 10 illustrates a process 1000 for building a disk utilization model and a database growth model. Using a physical data model 1010, a disk utilization model is created (step 1020). The disk utilization model describes the necessary disk capacity for each device. For each compute device, the disk utilization model includes information concerning storage device (here, disk drives) capacity associated with the compute device. The disk drive information may include the data transfer rate of the disk drive as measured by input/output (I/O) throughput per second, an amount for optional I/O throughput available for the disk drive, the number of additional disks required for system software (e.g., operating system, database management system, database manager system log, transaction manager, application software), the cache hit ratio, the number of logical I/O operations per second required to support database operations, the number of logical I/O operations per second required for non-database operations, the total number of logical I/O operations per second (e.g., the sum of the database operations and the non-database operations), the logical I/O bandsize per second required, the physical I/O operations per second required, the required I/O throughput capacity, the number of disk drives required that does not include a pre-determined number for operating system, database management system, transaction manager, and application software (which may be referred to as the base number of disk drives required), and the adjusted number of disk drives required (which is the base number of disk drives multiplied by some factor, such as twenty percent). The disk utilization report may be produced from the disk utilization model (step 1030).

Alternatively or additionally, the physical data model may be used to create a database growth model (step 1040). The database growth model describes the expected increase in the database size over time. The database growth model includes the identification of the data store (such as the database table or a dataset that includes one or more database tables), the server type (such as a database server, enterprise server, organization site server, application server), the database size base estimate (typically, in gigabytes), the number of years to calculate growth, the growth rate per year (in percentage of database size), the raw size after number of years (in gigabytes), the percent growth estimated to be in the dynamic database, the size of the dynamic database (in gigabytes), the dynamic database factor (which also may be referred to as a “multiple”), the adjusted dynamic database size (in gigabytes) after multiplying the dynamic database size by the dynamic database factor, the static database size (in gigabytes), the static database factor (or “multiple”), and the adjusted the static database size (in gigabytes) after multiplying the static database size by the static database factor. A database growth report that estimates database growth may be produced (step 1050).

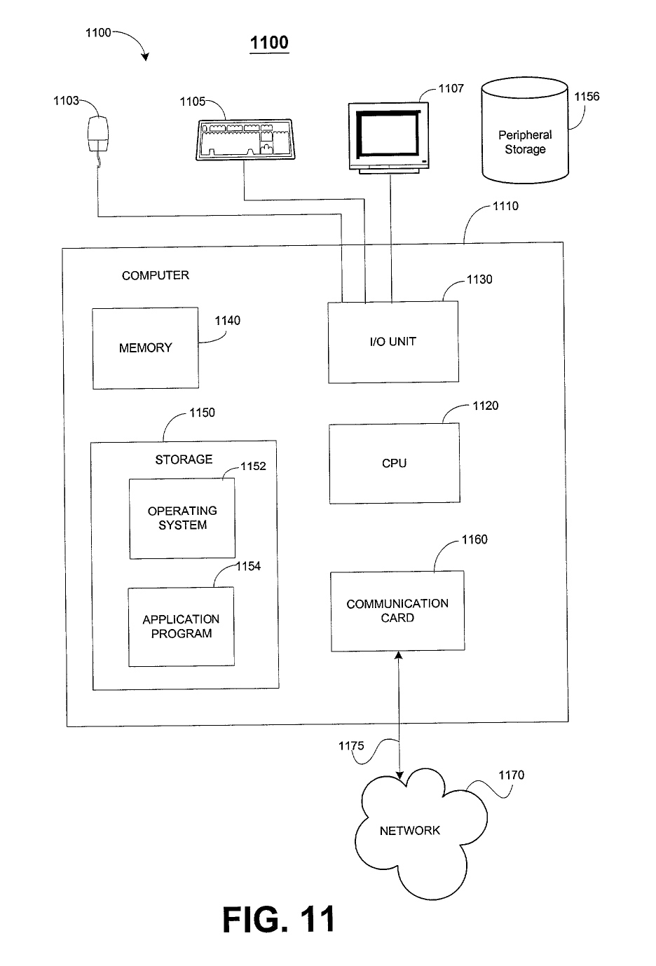

Referring to FIG. 11, a programmable system 1100 for performing capacity planning includes a variety of input/output (I/O) devices (e.g., mouse 1103, keyboard 1105, and display 1107) and a computer 1110 having a central processor unit (CPU) 1120, an I/O unit 1130, a memory 1140, and a data storage device 1150. Data storage device 1150 may store machine-executable instructions, data, and various programs such as an operating system 1152 and one or more application programs 1154 for implementing a capacity planning process, all of which may be processed by CPU 1120. Each computer program may be implemented in a high-level procedural or object-oriented programming language, or in assembly or machine language if desired; and in any case, the language may be a compiled or interpreted language. Data storage device 150 may be any form of non-volatile memory, including by way of example semiconductor memory devices, such as Erasable Programmable Read-Only Memory (EPROM), Electrically Erasable Programmable Read-Only Memory (EEPROM), and flash memory devices; magnetic disks such as internal hard disks and removable disks; magneto-optical disks; and Compact Disc Read-Only Memory (CD-ROM).

System 1100 may include one or more peripheral online storage devices 1156 for storing capacity planning data. Peripheral online storage device 1156 may use any storage media (including magnetic, optical or solid state storage media) or any type of storage device (including a drive, a microdrive, a compact disc (CD), CD-recordable (CD-R), CD-rewriteable (CD-RW), flash memory, or solid-state floppy disk cards (SSFDC)).

System 1100 also may include a communications card or device 1160 (e.g., a modem and/or a network adapter) for exchanging data with a network 1170 using a communications link 1175 (e.g., a telephone line, a wireless network link, a wired network link, or a cable network). Other examples of system 1100 may include a handheld device, a workstation, a server, a device, a component, other equipment, or some combination of these capable of responding to and executing instructions in a defined manner. Any of the foregoing may be supplemented by, or incorporated in, ASICs (application-specific integrated circuits).

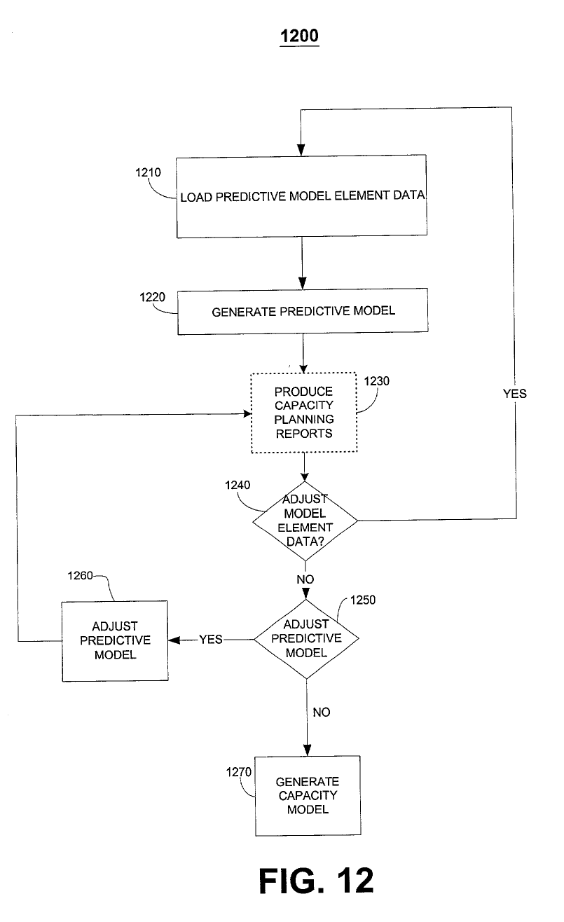

Referring to FIG. 12, a process 1200 controls a processor to generate a capacity model. The process 1200 is initiated when predictive model element data is loaded (step 1210). Predictive model element data may be loaded using a utility program that permits data relevant to capacity planning that has been gathered, for instance, using process 100 described above with respect to FIG. 1, to be loaded into a capacity planning modeling tool or database.

The predictive model element data is used to generate one or more predictive models (step 1220) and, optionally, to produce one or more capacity planning reports (step 1230), such as described previously with respect to FIGS. 3-10. The processor provides a user interface that allows a user to adjust predictive model data elements (step 1240) or to adjust the one or more predictive models (steps 1250-1260). The user may adjust the predictive model element data or one or more of the predictive models repeatedly (steps 1240-1260). When the user no longer wishes to adjust the predictive model element data used or the predictive models generated, the processor generates the capacity model (step 1270).

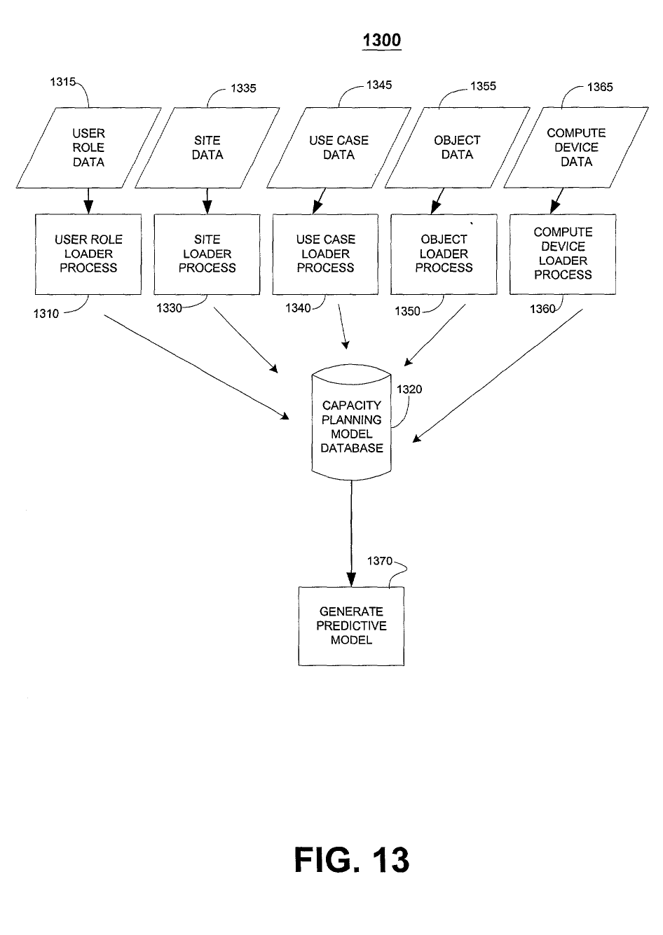

FIG. 13 illustrates a process 1300 that is a more specific example of a process for loading model element data to a capacity planning model database and generating predictive models. For example, using a version of Excel available from Microsoft Corporation, one or more electronic spreadsheets for each type of model element data can be created. The electronic spreadsheet may include a column for each type of model data element and a row for each record of model data to be loaded into the capacity planning model database. The capacity planning model database may be developed by using Rational Roseg, a visual modeling product available from Rational Software. The spreadsheet data may be loaded into the capacity planning model using Rational REI (Rose Extensibility Interface) that is also available from Rational Software.

A user role loader process (step 1310) may be used to load a user role spreadsheet that has user role data 1315 into the capacity planning model database 1320. The user role spreadsheet includes a row for each user role and has columns that include name and a description for each user role.

A site loader process (step 1330) may be used to load a spreadsheet that has site data 1335 into the capacity planning model database 1320. The site spreadsheet includes a row for each organization site and has columns that include site name, address (street address, city, and state), telephone number area code and prefix, and an indication whether the site uses dial-up connections for communications.

A use case loader process (step 1340) may be used to load a spreadsheet that has use case data 1345 into the capacity planning model database 1320. The use case spreadsheet includes a row for each use case and has columns that include use case information described with respect to FIG. 5.

An object loader process (step 1350) may be used to load a spreadsheet that has object data 1355 into the capacity planning model database 1320. Object data may include object class, attribute, and operation (or method) information. The object spreadsheet includes a row for each object and has columns that include object class information the same or similar to the object class information described above with respect to FIGS. 3 and 4. Additionally or alternatively, an object may include an architecture column that indicates which type of architecture to which the object relates, such as an information architecture, an application architecture, an infrastructure architecture, or systems management architecture.

A compute device loader process (step 1360) may be used to load into the capacity planning model database 1320 a spreadsheet that has compute device data 1365. The compute device spreadsheet includes a row for each compute device and has columns that include compute device information the same or similar to the compute device information described above with respect to FIG. 5.

The loader processes and spreadsheets described with respect to FIG. 12 are illustrative. Some implementations may use other spreadsheets or other methods of loading predictive model element data into a capacity planning model or database. For example, some implementations may use XML (Extensible Mark-up Language) to load data into a capacity planning model or database.

The processor generates one or more predictive models based on the data available in the capacity planning model database 1320 (step 1370). The predictive models may be the same or similar to the predictive models described with respect to FIGS. 3-10.

The predictive models produced may be adjusted as described above with respect to FIGS. 1 and 12.

Implementations may include a method or process, an apparatus or system, or computer software on a computer medium. It will be understood that various modifications may be made without departing from the spirit and scope of the following claims. For example, advantageous results still could be achieved if steps of the disclosed techniques were performed in a different order and/or if components in the disclosed systems were combined in a different manner and/or replaced or supplemented by other components. Advantageous results could be achieved if the disclosed techniques for a capacity planning process were applied to computer system sizing or computer system performance planning. Advantageous results could be achieved if the disclosed techniques were applied to an application program that used an object database system, or some other data abstraction tool, rather than the relational database system used as an illustration.

Other implementations are within the scope of the following claims.

What is claimed is:

1. A computer-implemented method for capacity planning for a computer system, the method comprising:
providing planning information to one or more computer systems;
generating one or more predictive models using the provided planning information and at least one of the one or more computer systems;
validating the one or more predictive models using at least one of the one or more computer systems;
generating a capacity model based on the one or more predictive models using at least one of the one or more computer systems; and
repeating the generating and validating of the one or more predictive models and the generating of the capacity model as more planning information is provided.

2. The method of claim 1 wherein the planning information comprises system component information.

3. The method of claim 2 wherein the planning information comprises compute device information.

4. The method of claim 1 wherein the planning information comprises data model information and generating one or more predictive models comprises generating a data class model using the data model information.

5. The method of claim 1 wherein the planning information comprises data usage information and generating one or more predictive models comprises generating a case use model using the data usage information.

6. The method of claim 1 wherein the planning information comprises process model information and generating one or more predictive models comprises generating a case use model using the process model information.

7. The method of claim 1 wherein the planning information comprises location information and generating one or more predictive models comprises generating a communication traffic model using the location information.

8. The method of claim 1 wherein the planning information comprises application program information and generating one or more predictive models comprises generating a transaction model using application program information.

9. The method of claim 8 wherein application program information comprises data structure information.

10. The method of claim 8 wherein application program information comprises function information.

11. The method of claim 1 wherein one of the predictive models comprises a utilization model.

12. The method of claim 11 wherein the utilization model comprises a memory utilization model.

13. The method of claim 11 wherein the utilization model comprises a disk utilization model.

14. The method of claim 1 wherein one of the predictive models comprises a database growth model.

15. The method of claim 1 wherein the capacity model comprises memory requirements, disk requirements, and processor requirements for one or more components in a computer system.

16. The method of claim 1 wherein the validating one or more predictive models comprises using a system simulation model.

17. The method of claim 1 further comprising generating capacity planning reports using the one or more predictive models.

18. The method of claim 1 wherein:
generating the one or more predictive models comprises generating the one or more predictive models using a data modeling system, and
generating the capacity model comprises generating the capacity model using the data modeling system,
the method further comprising loading capacity planning information into the data modeling system.

19. A computer-readable medium or propagated signal having embodied thereon a computer program configured to restore data, the medium comprising a code segment configured to:
provide planning information to one or more computer systems;
generate one or more predictive models using the provided planning information and at least one of the one or more computer systems;
validate the one or more predictive models using at least one of the one or more computer systems;
generate a capacity model based on the one or more predictive models using at least one of the one or more computer systems; and
repeat the generating and validating of the one or more predictive models and the generating of the capacity model as more planning information is provided.

20. The medium of claim 19 wherein the planning information comprises system component information.

21. The medium of claim 20 wherein the planning information comprises compute device information.

22. The medium of claim 19 wherein the planning information comprises data model information and generating one or more predictive models comprises generating a data class model using the data model information.

23. The medium of claim 19 wherein the planning information comprises data usage information and generating one or more predictive models comprises generating a case use model using the data usage information.

24. The medium of claim 19 wherein the planning information comprises process model information and generating one or more predictive models comprises generating a case use model using the process model information.

25. The medium of claim 19 wherein the planning information comprises location information and generating one or more predictive models comprises generating a communication traffic model using the location information.

26. The medium of claim 19 wherein the planning information comprises application program information and generating one or more predictive models comprises generating a transaction model using application program information.

27. The medium of claim 26 wherein the application program information comprises data structure information.

28. The medium of claim 26 wherein the application program information comprises function information.

29. The medium of claim 19 wherein one of the predictive models comprises a utilization model.

30. The medium of claim 29 wherein the utilization model comprises a memory utilization model.

31. The medium of claim 29 wherein the utilization model comprises a disk utilization model.

32. The medium of claim 19 wherein one of the predictive models comprises a database growth model.

33. The medium of claim 19 wherein the capacity model comprises memory requirements, disk requirements, and processor requirements for one or more components in a computer system.

34. The medium of claim 19 wherein the code segment configured to validate one or more predictive models is configured to use a system simulation model.

35. The medium of claim 19 further comprising a code segment configured to generate capacity planning reports using the one or more predictive models.

36. The medium of claim 19 wherein:
the code segment configured to generate the one or more predictive models is configured to generate the one or more predictive models using a data modeling system, and
the code segment configured to generate the capacity model is configured to generate the capacity model using the data modeling system,
the medium further comprising a code segment configured to load capacity planning information into the data modeling system.

37. A system for capacity planning for a computer system, the system comprising a processor connected to a storage device and one or more input/output devices, wherein the processor is configured to:
provide planning information to one or more computer systems;
generate one or more predictive models using the provided planning information and at least one of the one or more computer systems;
validate the one or more predictive models using at least one of the one or more computer systems;
generate a capacity model based on the one or more predictive models using at least one of the one or more computer systems; and
repeat the generating and validating of the one or more predictive models and the generating of the capacity model as more planning information is provided.

38. The system of claim 37 wherein the planning information comprises system component information.

39. The system of claim 38 wherein the planning information comprises compute device information.

40. The system of claim 37 wherein the planning information comprises data model information and the processor is configured to use the data model information to generate a data class model as one of the one or more predictive models.

41. The system of claim 37 wherein the planning information comprises data usage information and the processor is configured to use the data usage information to generate a case use model as one of the one or more predictive models.

42. The system of claim 37 wherein the planning information comprises process model information and the processor is configured to use the process model information to generate a case use model as one of the one or more predictive models.

43. The system of claim 37 wherein the planning information comprises location information and the processor is configured to use the location information to generate a communication traffic model as one of the one or more predictive models.

44. The system of claim 37 wherein the planning information comprises application program information and the processor is configured to use the application program information to generate a transaction model as one of the one or more predictive models.

45. The system of claim 44 wherein application program information comprises data structure information.

46. The system of claim 44 wherein application program information comprises function information.

47. The system of claim 37 wherein one of the predictive models comprises a utilization model.

48. The system of claim 47 wherein the utilization model comprises a memory utilization model.

49. The system of claim 47 wherein the utilization model comprises a disk utilization model.

50. The system of claim 37 wherein one of the predictive models comprises a database growth model.

51. The system of claim 37 wherein the capacity model comprises memory requirements, disk requirements, and processor requirements for one or more components in a computer system.

52. The system of claim 37 wherein the processor is configured to validate one or more predictive models using a system simulation model.

53. The system of claim 37 wherein the processor is further configured to generate capacity planning reports using the one or more predictive models.

54. The system of claim 37 wherein the processor is configured to:
load capacity planning information into a data modeling system,
generate the one or more predictive models using the data modeling system, and
generate the capacity model using the data modeling system.
